(19) United States
(12) Patent Application Publication
(10) Pub. No.: US 2025/0078721 A1
(43) Pub. Date: Mar. 6, 2025

(54) MEMORABILIA VIDEO AND PICTURE DISPLAY SYSTEM AND APPARATUS

(71) Applicant: Robert Lee Braddy, JR., Atlanta, GA (US)

(72) Inventor: Robert Lee Braddy, JR., Atlanta, GA (US)

(21) Appl. No.: 18/822,263

(22) Filed: Sep. 1, 2024

Related U.S. Application Data
(60) Provisional application No. 63/536,126, filed on Sep. 1, 2023.

(51) Int. Cl. G09G 3/20; A47G 1/06; G06F 3/147; H04L 67/06

(52) U.S. Cl. CPC G09G 3/2092; A47G 1/0616; G06F 3/147; H04L 67/06; G09G 2380/16

(57) ABSTRACT

The present disclosure is directed a system and apparatus for displaying personalized multimedia associated with a collectible or other type of memorabilia. Embodiments of this disclosure describe a visual display capable of being disposed on or inside a cavity of a shell for a collectible that can receive images or videos via a communications interface for displaying personalized multimedia with the collectible.

### CROSS-REFERENCE TO RELATED APPLICATIONS

This application claims priority to U.S. Provisional Application No. 63/536,126 filed on Sep. 1, 2023, the entirety of which is herein incorporated by reference.

### FIELD

The present disclosure generally relates to the technical field of collectibles. More specifically, the present disclosure is directed to a system and apparatus for displaying personalized multimedia disposed within or on a collectible or commemorative object.

### BACKGROUND

Traditionally, memorabilia or collectibles such as sports or commemorative memorabilia refers to objects or devices used to commemorate certain events or shared affection for a certain sport, occupation, or experience (the term “collectible” is used to refer collectively to memorabilia that commemorates or celebrates a certain event, team, occupation, celebrity, etc.). Presently, the items have largely remained static in that they remain in place and only provide external visual interaction without personalization. However, collectors face challenges in capturing and showcasing their prized possessions. Specifically, collectors may create elaborate cases or include displays that contain additional information and/or visual representations that are specific to the memorabilia. Often, collectors rely on external devices or complex procedures to enhance the collectible. These displays or additional enhancement features are elaborate and expensive. Furthermore, the time it takes to enhance memorabilia is significant and requires third party vendors to design and create these features.

The present disclosure is directed at integrating memorabilia or collectibles with a visual display disposed with in a cavity of the object or device and a communication interface for seamlessly transferring photos or videos to empower collectors to easily document and share their experiences. This disclosure allows users to customize their collectibles in a less costly and efficient manner. Through embodiments of the present disclosure, users and collectors of memorabilia and collectibles can enhance the emotional connection and sentimental value associated with the object or device. Moreover, it allows users to showcase their pride, loyalty, and personal experiences within a wide array of categories to include different sports and other experiences.

The present disclosure provides a unique and personalized touch, catering to the preferences and desires of the user who want to display their own images alongside their favorite sports teams, athletes, entertainer, celebrity, occupation, etc. Embodiments of the present disclosure provide a personal and individualistic touch while elevating the overall collecting experience for a variety of fans, allowing them to create meaningful connections with their collectibles.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, in which:

FIG. 1 illustrates a cross sectional view of a collectible in accordance with various embodiments of the present disclosure.

FIG. 2 illustrates a cross sectional view of a collectible in accordance with various embodiments of the present disclosure;

FIG. 3 illustrates the front view of a collectible in accordance with various embodiments of the present disclosure.

The illustrated figures are only exemplary and are not intended to assert or imply any limitation with regard to the environment, architecture, design, or process in which different embodiments may be implemented.

### SUMMARY

The disclosed embodiments include a collectible apparatus for displaying videos and images. In one embodiment, the collectible apparatus comprises a shell defined by an inner and outer surface; wherein the inner surface of the collectible defines a cavity; the shell having a port configured to hold a viewing lens that is configured to view a visual display screen disposed within the cavity from the outer surface of the collectible; and wherein the visual display is communicatively coupled to a wireless receiver configured to receive images or videos from a wireless source for viewing on the visual display; wherein the collectible further comprises at least one speaker disposed on the exterior or interior surface of the collectible that is electronically coupled to the visual display.

The disclosed embodiments include a system for viewing images or videos within in a collectible, comprising: memory configured to store instructions; a processor configured to execute the instructions stored in the memory to: wirelessly receive images or videos onto a visual display disposed within a cavity of the collectible, wherein the visual display is configured to be viewed through a lens disposed with an inner and outer shell that surrounds the cavity, wherein the visual display is configured to display images or videos and is electronically coupled to at least one speaker disposed on the outer shell of the collectible for projecting sounds associated with the image or video being played on the visual display. In various embodiments, a button is disposed on the outer shell of the collectible and configured to be depressed which enables the image or video to be displayed on the visual display disposed within the cavity.

The disclosed embodiments include a system for viewing images or videos on a collectible, comprising: memory configured to store instructions; a processor configured to execute the instructions stored in the memory to: wirelessly receive images or videos onto a visual display disposed on the outer surface of the collectible, wherein the visual display is embedded in the collectible and configured to display images or videos. In various embodiments, a button is disposed on the outer surface of the collectible and configured to be depressed which enables the image or video to be displayed on the visual display. In some embodiments, the outer surface or shell is configured to incorporate a speaker for projecting sounds associated with the image or video being displayed on the visual display.

The above summary merely provides examples of particular embodiments disclosed herein and are not intended to be exhaustive or limit the scope of the claims. Other embodiments and advantages of the disclosed embodiments will be further described in the detailed description.

### DETAILED DESCRIPTION

This description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

As used herein, use of a singular article such as “a,” “an” and “the” is not intended to exclude pluralities of the article's object unless the context clearly and unambiguously dictates otherwise

These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The embodiments discussed herein pertain to an apparatus, system(s), method(s), or computer readable medium(s) for receiving images and/or videos onto a visual display disposed within a cavity of a collectible object, wherein the visual display can be viewed using a lens. In various embodiments, the visual display is disposed on an outer surface of the collectible.

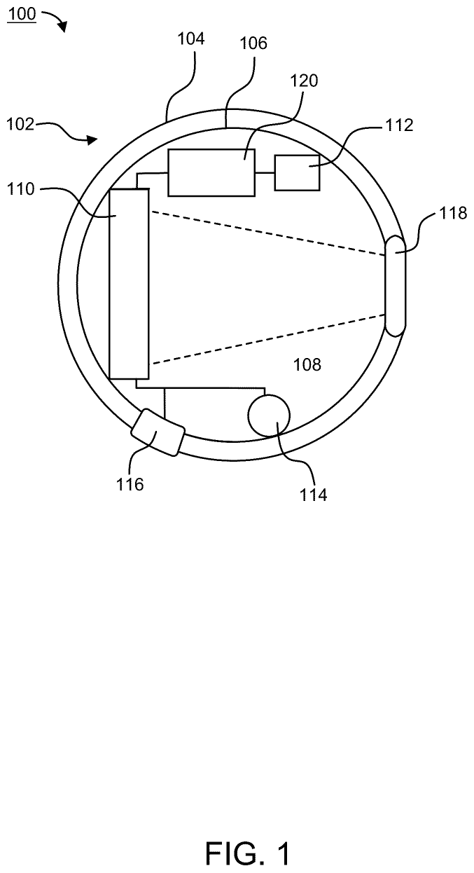

FIG. 1 depicts a cross sectional view of a collectible in accordance with various embodiments of the present disclosure. According to various embodiments a collectible 100 is depicted in FIG. 1. The collectible 100 comprises a shell 102 having an outer surface 104 and an inner surface 106. The inner surface 106 defines a cavity 108 disposed within the collectible 100 and shell 102. The cavity 108 comprises a visual display 110, a communications interface 112, and a battery 114. Collectible 100 further comprises a power source 116 disposed on the outer surface 104 of shell 102. In various embodiments, collectible 100 comprises a viewing port or lens 118 disposed between the outer surface 104 and inner surface 106 of the shell 102 and configured to view the visual display 110.

In various embodiments collectible 100 is configured to receive images or videos for display on the visual display 110 disposed within the cavity 108 via the lens 118. According to some embodiments, the collectible 100 is configured to receive the images or videos wirelessly from a user's client device (not shown) via communications interface 112. Client devices include any device capable of transmitting and receiving wireless signals. Examples of client devices include, but are not limited to, mobile or cellular phones, smart phones. personal digital assistants (“PDAs”), laptop computers, tablet computers, music players, wearable peripheral devices, and e-readers, to name a few possible devices.

Collectible 100 further comprises one or more processors 120. Processor(s) 120 may be any central processing unit (“CPU”), microprocessor, micro-controller, or computational device or circuit for executing instructions. Processor(s) are connected to a communication infrastructure (not shown) (e.g., a communications bus, cross-over bar, or network). The processor(s) 120 are configured to receive information received from communications interface 112, and store the information (i.e., images and/or videos) in memory (not shown) for displaying on visual display 110.

According to various embodiments collectible 100 comprises a visual display 110 disposed within the cavity 108. Visual display 110 is capable of displaying graphics, video, text, and other data received from the communication infrastructure (or from a frame buffer not shown). Examples of visual display 110 include, but are not limited to, LCD screens, LED and OLED displays, capacitive touch screen, and a plasma display, to list only a few possible displays. Collectible 100 may also include a main memory, such as a random access (“RAM”) memory, and may also include a secondary memory. Secondary memory may include a more persistent memory such as, for example, a hard disk drive (“HDD”) and/or removable storage drive (“RSD”), representing a magnetic tape drive, an optical disk drive, solid state drive (“SSD”), or the like. In some embodiments, removable storage drive reads from and/or writes to a removable storage unit (“RSU”) in a manner that is understood by one of ordinary skill in the art. Removable storage unit represents a magnetic tape, optical disk, or the like, which may be read by and written to by removable storage drive. As will be understood by one of ordinary skill in the art, the removable storage unit may include a tangible and non-transient machine-readable storage medium having stored therein computer software and/or data.

In some embodiments, secondary memory may include other devices for allowing computer programs or other instructions to be loaded into collectible 100. Such devices may include, for example, a removable storage unit (“RSU”) and a corresponding interface (“RSI”). Examples of such units and interfaces may include a removable memory chip (such as an erasable programmable read only memory (“EPROM”)), programmable read only memory (“PROM”)), secure digital (“SD”) card and associated socket, and other removable storage units and interfaces, which allow software and data to be transferred from the removable storage unit to collectible 100.

In various embodiments, collectible 100 may also include a speaker, an oscillator, a camera, a light emitting diode (“LED”), a microphone, an input device, an accelerometer (not shown), and/or a global positioning system (“GPS”) module. Examples of input devices include, but are not limited to, a keyboard, buttons, a trackball, or any other interface or device through which a user may input data. In some embodiment, input device and visual display are integrated into the same device. In various embodiments, the LED is configured to indicate operations of collectible 100. For example, operations may include uploading information to collectible 100, power and/or charging status, on/off indication, wireless transmission and/or connection indications, etc.

Collectible 100 also includes one or more communication interfaces 112, which allows software and data to be transferred between collectible 100 from external devices such as, for example, a user's client device (e.g., mobile phone, etc.), a computer and other devices that may be locally or remotely connected to collectible 100. Examples of the one or more communication interfaces may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces may also include a wireless interface configured for short range communication, such as near field communication (“NFC”), Bluetooth, or other interface for communication via another wireless communication protocol.

Software and data transferred via the one or more communications interfaces are in the form of signals, which may be electronic, electromagnetic, optical, or other signals capable of being received by communications interfaces. These signals are provided to communications interface 112 via a communications path or channel. The channel may be implemented using wire or cable, fiber optics, a telephone line, a cellular link, a radio frequency (“RF”) link, or other communication channels.

In this document, the terms “non-transitory computer program medium” and “non-transitory computer readable medium” refer to media such as removable storage units, or a hard disk installed in hard disk drive. These computer program products provide software to collectible 100. Computer programs (also referred to as “computer control logic”) may be stored in main memory and/or secondary memory. Computer programs may also be received via the one or more communications interfaces 112. Such computer programs, when executed by a processor(s), enable the collectible 100 to perform the features of the method discussed herein.

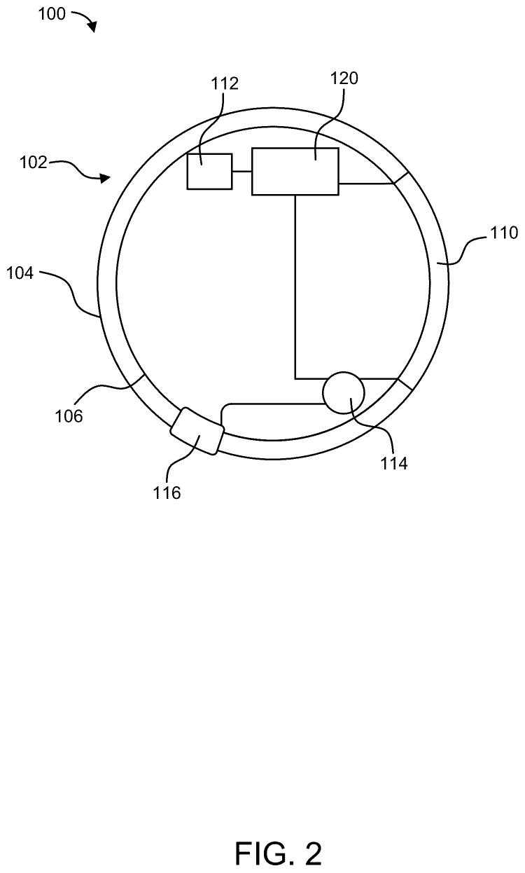

As previously discussed, a visual display 110 is disposed within a cavity 108 of collectible 100. FIG. 2 depicts a cross sectional view of a collectible in accordance with various embodiments of the present disclosure. According to various embodiments the collectible 100 comprises a shell 102 having an outer surface 104 and an inner surface 106. The inner surface 106 defines a cavity 108 disposed within the collectible 100 and shell 102. The cavity 108 comprises a communications interface 112, and a battery 114. As depicted in the embodiments of FIG. 2, a visual display 110 is disposed on the outer surface of shell 102. In various embodiments, the outer shell 102 of collectible 100 is formed to incorporate a visual display. Collectible 100 further comprises a power source 116 disposed on the outer surface 104 of shell 102. In various embodiments, collectible 100 comprises a viewing port or lens 118 disposed between the outer surface 104 and inner surface 106 of the shell 102 and configured to view the visual display 110.

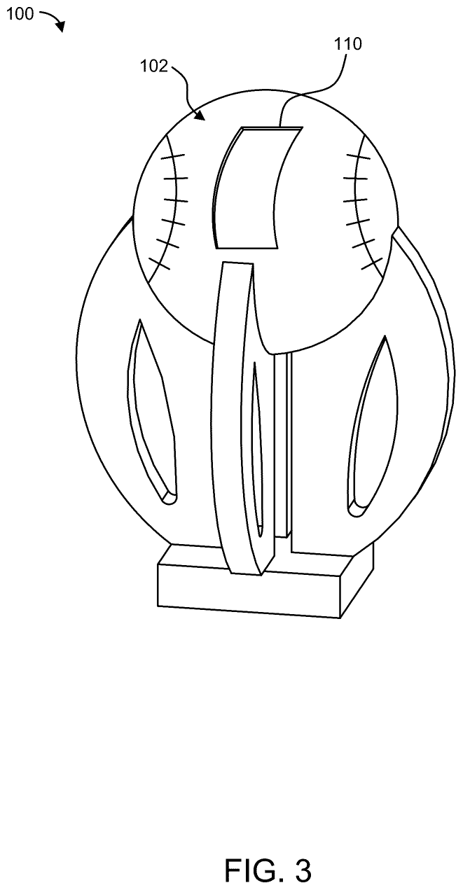

FIG. 3 illustrates the front view of a collectible in accordance with various embodiments of the present disclosure. According to various embodiments, the collectible 100 outer shell 102 is formed in the shape of a sports instrument. Examples of sports instruments include, but are not limited to, baseballs, footballs, basketballs, hockey pucks, etc. A person of ordinary skill in the art will understand that the outer shell of the collectible is associated with the sport, event, or person associated with the collectible. For example, an NBA finals collectible outer shell would be a basketball or sneaker.

In various embodiments, users are able to transfer a variety of multimedia items to collectible 100 via communication interfaces, both wired and wireless. In various embodiments, a user's client device is capable of interfacing with the collectible 100 via the various communication interfaces. For example, a user's client device may contain an application configured to connect to the collectible 100. In various embodiments, the application has a user interface that allows users, customers, parents, and collectors to interact with the collectible 100 and the platform and perform various actions.

In various embodiments, the client device application is capable of connecting to a server capable of hosting at least one collectible 100. In this embodiment, the server is connected to a database and database management system capable of cataloging at least one collectible 100 in a categorized and searchable manner. It should be apparent that these same capabilities may be obtained in a user's client device to enable the user to browse and discover items of interest or identify other collectibles.

In various embodiments, the collectible 100 is configured to authenticate and verify data transfers from partnerships or trusted sources. For example, a third party may authenticate the authenticity of a listed collectible by interfacing with the collectible via the communication interface and storing a digital certificate or token within memory of the collectible. In various embodiments, partnerships with trusted sources to authenticate and verify the authenticity of listed collectibles, ensures buyers' confidence in their purchases.

In some embodiments, applications on a client's device associated with collectible 100 are configured to provide social media sharing and engagement features. In this example, applications can facilitate social sharing, discussions, and interactions among collectors, creating a vibrant community within the platform. In some embodiments, the application on client's device provides tools and capabilities for collectors to negotiate prices, communicate, and finalize transactions within a secure environment.

In various embodiments, collectible 100 is configured to provide augmented reality (AR) and virtual reality (VR) features when being viewed using special peripherals. For example, collectible 100 may display a video that was uploaded above the collectible 100 when viewed using a phone camera or virtual reality headset. One of ordinary skill in the art will appreciate that the integration of AR/VR capabilities provides collectors with the ability to virtually interact with their collectibles, view them in immersive environments, or participate in virtual trading events.

In some embodiments, data transfer and/or authentication verification services are provided using blockchain technology for enhanced authentication and provenance tracking. Implementing blockchain-based solutions would provide a secure and transparent record of collectible ownership, ensuring the authenticity and traceability of items in the marketplace.

### Use Cases:

For Consumers: Consumers can register on the collectible 100 platform and browse through a diverse catalog of collectibles. They can discover exclusive items related to their favorite sports teams, celebrities, movies, or franchises. They can view detailed descriptions, images, and pricing information to make informed purchase decisions. Consumers can also engage with the collector community, participate in discussions, and explore social sharing features to showcase their own collectibles.

For Parents: Parents can utilize the collectible 100 platform to manage and document their children's collectibles. They can easily upload photos and videos using WI-FI and Bluetooth, providing a convenient way to capture and share their children's prized possessions. Parents can also authenticate and verify the authenticity of collectibles before making purchases, ensuring they are acquiring genuine items for their children's collections.

For Collectors: Collectors can leverage the collectible 100 platform to document, showcase, and trade their collectibles. They can upload photos and videos of their prized possessions, providing a comprehensive record of their collections. Collectors can engage with other enthusiasts, discuss their favorite items, and explore trading opportunities within the platform. The authentication and verification features give collectors confidence in the authenticity of items listed on the platform, enabling secure transactions, and fostering trust among collectors.

In various embodiments, collectible 100 is configured with a proximity sensor to detect other collectible(s) in the immediate vicinity. In some embodiments, collectible 100 is configured with NFC detection to detect other collectible(s). In some embodiments, collectible 100 is configured to sense other collectibles and perform additional audio and/or visual indications to signify the presence. In some embodiments, this may be LED lights or other audio. For example, when a collector possesses a complete collection of a subset of collectibles additional features may be activated on the application used to inventory the collectible(s). In some embodiments, collectible 100 includes a feature configured to signify its authenticity. For example, the collectible 100 may include some type of communication or code (bar code, captcha, etc.) where the authenticity of the collectible may be verified.

It should be apparent from the foregoing that an invention having significant advantages has been provided. While the foregoing has described and depicted what is considered to be the best mode and/or other examples, it is understood that various modifications may be made therein and that the subject matter disclosed herein may be implemented in various forms and examples, and that the teachings may be applied in numerous applications, only some of which have been described herein. Those skilled in the art will recognize that the present disclosure is amenable to a variety of modifications and/or enhancements. Such modifications are intended to be covered within the true scope of the present teachings.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

It may be emphasized that the above-described embodiments, are merely possible examples of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

While this specification contains many specifics, these should not be construed as limitations on the scope of any disclosure or of what may be claimed, but rather as descriptions of features that may be specific to particular embodiments of particular disclosures. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof.

What is claimed is:

1. A collectible for displaying videos or images, comprising:
a shell defined by an inner and outer surface, wherein the inner surface defines a cavity;
the shell having a port configured to hold a lens capable of viewing a visual display disposed within the cavity from the outer surface of the collectible; and
wherein the visual display is communicatively coupled to a communications interface configured to receive images or videos for viewing on the visual display.

2. The collectible of claim 1, wherein the communications interface is configured to wirelessly receive images or videos for viewing on the visual display.

3. The collectible of claim 2, wherein the collectible further comprises a speaker disposed on the shell of the collectible and electronically coupled to the visual display.

4. The collectible of claim 3, further comprising a battery disposed within the cavity of the collectible and electronically coupled to a power source for charging the battery, wherein the battery and/or power source is capable of providing power to the visual display.

5. The collectible of claim 4, further comprising a button disposed on the outer surface of the shell and configured to activate the visual display, to display images and/or videos.

6. The collectible of claim 5, further comprising memory configured to receive a token or certificate that can be accessed via the communications interface.

7. The collectible of claim 5, further comprising a light emitting diode disposed on the outer surface of the collectible and configured to act as a visual indicator of operations for the collectible.

8. A collectible for displaying videos or images, comprising:
a shell defined by an inner and outer surface, wherein the inner surface defines a cavity;
the shell configured to receive a visual display such that the shell is formed around an outer edge of the visual display such that the cavity is formed from the combination of the shell and visual display;
wherein the visual display is communicatively coupled to a communications interface configured to receive images or videos for viewing on the visual display; and
wherein the shell is formed in the shape of a sports instrument.

9. The collectible of claim 8, wherein the communications interface is configured to wirelessly receive images or videos for viewing on the visual display.

10. The collectible of claim 9, wherein the collectible further comprises a speaker disposed on the shell of the collectible and electronically coupled to the visual display.

11. The collectible of claim 10, further comprising a battery disposed within the cavity of the collectible and electronically coupled to a power source for charging the battery, wherein the battery and/or power source is capable of providing power to the visual display.

12. The collectible of claim 11, further comprising a button disposed on the outer surface of the shell and configured to activate the visual display, to display images and/or videos.

13. The collectible of claim 12, further comprising memory configured to store a token or certificate that can be accessed via the communications interface.

14. The collectible of claim 5, further comprising a light emitting diode disposed on the outer surface of the collectible and configured to act as a visual indicator of operations for the collectible.

15. A collectible for displaying videos or images, comprising:
a shell defined by an inner and outer surface, wherein the inner surface defines a cavity;
the shell configured to receive a visual display such that the shell is formed around an outer edge of the visual display such that the cavity is formed from the combination of the shell and visual display;
wherein the visual display is communicatively coupled to a communications interface configured to wirelessly receive images or videos for viewing on the visual display;
a speaker disposed on the shell of the collectible and electronically coupled to the visual display;
a battery disposed within the cavity of the collectible and electronically coupled to a power source for charging the battery, wherein the battery and/or power source is capable of providing power to the visual display;
a button disposed on the outer surface of the shell and configured to activate the visual display, to display images and/or videos; and
memory configured to store a token or certificate that can be accessed via the communications interface.
